(19) United States
(12) Patent Application Publication
(10) Pub. No.: US 2007/0113409 A1
(43) Pub. Date: May 24, 2007

(54) Electric shaving apparatus with a pivotal shaving head

(76) Inventor: Uwe Schaaf, Alsbach-Hahnlein (DE)

Correspondence Address: FISH & RICHARDSON PC, P.O. BOX 1022, MINNEAPOLIS, MN, 55440-1022, US

(21) Appl. No.: 11/635,337

(22) Filed: Dec. 7, 2006

Related U.S. Application Data
(63) Continuation of application No. PCT/EP05/05892, filed on Jun. 1, 2005.

(30) Foreign Application Priority Data
Jun. 9, 2004 (DE) 10 2004 028 064.9

(51) Int. Cl. B26B 19/02

(52) U.S. Cl. 30/43.92

(57) ABSTRACT

There is provided an electric shaving apparatus including a pivotal shaving head. More specifically, in one embodiment, there is provided an electric shaving apparatus including a housing, a shaving head pivotal relative to the housing and including at least one shaving system, and an electric drive mechanism for driving at least one component of the shaving system. The drive mechanism includes a stationary stator and at least one rotor movable relative to the stator, wherein the stator is disposed in the housing and the rotor in the shaving head.

### CROSS-REFERENCE TO RELATED APPLICATIONS

This application is a continuation application of and claims priority under 35 U.S.C. §120 to PCT/EP2005/005892, filed on Jun. 1, 2005, and claims priority under 35 U.S.C. §119 from German application DE 10 2004 028 064.9, filed Jun. 9, 2004, both of which are hereby incorporated by reference in their entirety.

### TECHNICAL FIELD

This invention relates to an electric shaving apparatus. More specifically, in one configuration, the present invention relates to an electric shaving apparatus having a pivotal shaving head.

### BACKGROUND

As most people are aware, electric shaving apparatuses are a popular way to perform any one of a number of personal grooming tasks. A typically shaving apparatus may have a housing serving as a handle and a shaving head assembly that is adapted to pivot relative to the housing about a pivot axis. Furthermore, typical shaving apparatuses may also include an outer cutter and an undercutter. Moreover, as a large majority of the locations on the human body amenable to shaving are sloped, it is advantageous for an electric shaving apparatus to be capable of pivoting or tilting the shaving head. To provide this functionality, conventional tilting shaving systems typically employ a shaving head that includes an integral motor. However, a shaving head of this type is usually relatively heavy due to the presence of the motor.

An improved electric shaving system would be desirable.

### SUMMARY

In one configuration, there is provided an electric shaving apparatus including a housing, a shaving head pivotal relative to the housing and including at least one shaving system, and an electric drive mechanism for driving at least one component of the shaving system. The drive mechanism may also include a stationary stator and at least one rotor movable relative to the stator, wherein the stator is disposed in the housing and the rotor in the shaving head.

Advantageously, this configuration provides a driven component of the shaving system that is excitable into oscillations of high frequency, thereby enabling a thorough shave. Another advantage is the efficiency of the drive concept employed. Furthermore, it is an advantage that the stator is not located in the shaving head, thereby enabling the shaving head to be of small size and light weight. This allows the shaving apparatus to be handled comfortably, with the shaving head adjusting itself to a favorable pivot position.

In one configuration, a gap may be formed between the stator and the rotor. In this configuration, the stator and the rotor may be shaped such that the drive mechanism continues to be operable even though the shaving head inclusive of the rotor are pivoted relative to the housing. In particular, the stator and the rotor can be shaped in the region adjoining the gap in such manner that the magnetically effective width of the gap is maintained substantially constant as the shaving head is being pivoted. This design may enable consistently high efficiency of the drive mechanism over wide parts of the pivotable range. For example, the stator could be curved to a concave configuration in the region adjoining the gap and/or the rotor could be curved to a convex configuration in the region adjoining the gap.

In another embodiment, the rotor is connected fast (e.g. rigidly) with the driven component of the shaving system. This configuration enables a precise control of the driven component of the shaving system. In particular, the oscillation amplitude and the oscillation frequency of the driven component of the shaving system can be maintained constant during the shave to avoid sudden drops in oscillation.

In still another example, the rotor may be movably suspended on the shaving head so as to be moveable linearly. In particular, the rotor may be coupled to at least one element that is resilient parallel to the direction of movement of the rotor, whereby an oscillatory system is created which can be driven very efficiently. Parallel to the pivoting direction of the shaving head, the rotor is preferably rigidly connected with the shaving head, thereby causing it to be pivoted uniformly with the shaving head. For example, in one embodiment, the rotor is fastened to the shaving head by means of oscillating bridges.

In yet another embodiment, the shaving system includes at least one permanent magnet. Further, a pole shoe may also be disposed on a side of the permanent magnet facing the stator in order to obtain a desired geometry with little effort. In a further aspect of the shaving apparatus, a plurality of rotors which drive a plurality of components of the same shaving system and/or different shaving systems may be employed. In this configuration, complex shaving systems can be driven with low outlay.

In yet another aspect, control of the drive is accomplished by the stator including at least one winding adapted to be driven by a control device. In particular, the winding may be drivable by the control device such that the drive mechanism is operated at or close to its resonant frequency. The control device may be constructed such as to produce voltage pulses, (e.g., bipolar voltage pulses). For example, the control device may produce duration modulated voltage pulses that enable the power supplied to the winding to be controlled. In one embodiment of the control device, driving the winding may produce variations in the effective power of the drive mechanism that can be compensated for. Alternatively, the motion amplitude of the rotor can be adjusted to a constant value. This may enable a consistently good shaving result to be achieved despite changing outside influences.

In still another configuration, there is provided an electric drive mechanism for driving at least one component of a shaving system of a shaving head pivotal relative to a housing of an electric shaving apparatus. The drive mechanism may include a stationary stator and at least one rotor movable relative to the stator, wherein the stator is configured to be mounted in the housing and the rotor is configured to be mounted in the shaving head of the shaving apparatus.

### DESCRIPTION OF DRAWINGS

The present invention will be explained in greater detail in the following with reference to the embodiment illustrated in the accompanying drawings.

FIG. 1 is a schematic sectional view of an embodiment of an electric shaving apparatus constructed in accordance with the present invention; and

FIG. 2 is another schematic sectional view of the embodiment of the shaving apparatus illustrated in FIG. 1.

Like reference symbols in the various drawings indicate like elements.

### DETAILED DESCRIPTION

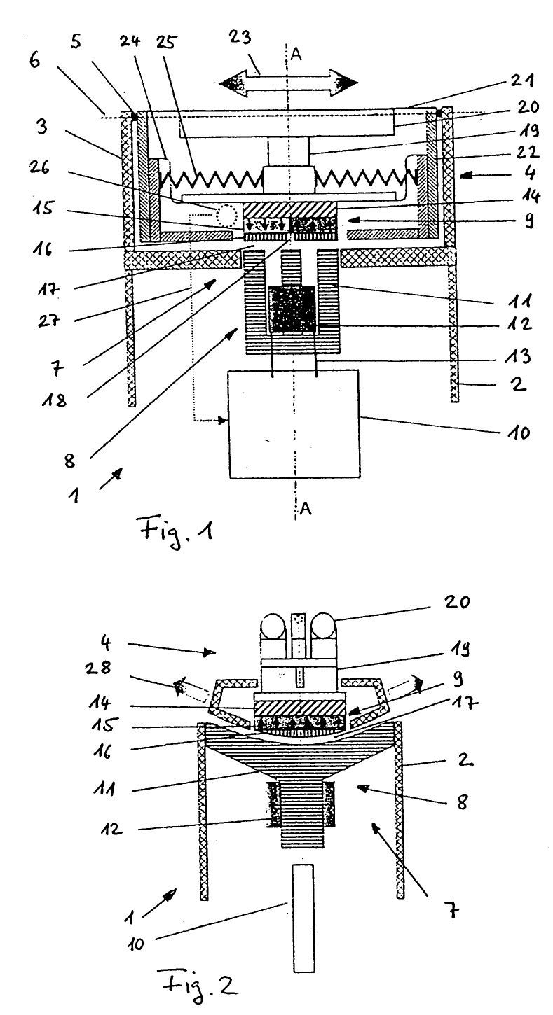

FIG. 1 shows an electric shaving apparatus 1 constructed in accordance with one embodiment in a schematic sectional view. The shaving apparatus 1 has a housing 2 shaped to enable a user to hold the shaving apparatus 1 in his hand. Fitted to the housing 2 are two supporting arms 3 on which a shaving head 4 is suspended by means of two journals 5 for pivotal motion about a pivot axis 6. The pivot axis 6 extends in the area of the shaving head 4 facing away from the housing 2. The shaving apparatus 1 further includes a linear oscillation motor 7 comprised of a stator 8 and a rotor 9. The stator 8 is disposed in the housing 2 which also may accommodate an electronic control unit 10 for controlling the linear motor 9. In other configurations, further suitable components not illustrated in the Figure, such as batteries, may also be included in the housing 2. The stator 8 includes an iron core 11, (e.g., a stacked assembly of soft magnetic steel laminations) and a winding 12 which may be divided into a plurality of coil sets. The cross-sectional area of the iron core 11 shown in FIG. 1 has the shape of an “E”, with the winding 12 embracing the center bar of the “E”. The winding 12 is connected to the electronic control unit 10 via connecting leads 13.

The rotor 9 is disposed in the shaving head 4 and includes a soft magnetic carrier plate 14 that mounts two permanent magnets 15 of anti-parallel polarity in a side-by-side arrangement. The directions of magnetization of the permanent magnets 15 are indicated by arrows and extend normal to the surface of the carrier plate 14 mounting the permanent magnets 15, so that the carrier plate 14 serves as rotor return path. Arranged on the two permanent magnets 15 are two soft magnetic pole shoes 16 reaching close to the iron core 11 of the stator 8 so that a narrow gap 17 is maintained between the pole shoes 16 and the iron core 11 in which no magnetic material is arranged. The gap 17 may be filled in part with a non-magnetic material. For example, the adjacent areas of the pole shoes 16 and of the iron core 11 may be coated with a plastic. However, at least part of the gap 17′ remains as an air gap to enable the rotor 9 to move relative to the stator 8.

Another gap 18 which is likewise devoid of magnetic material is provided between the two pole shoes 16. The gap 18 between the pole shoes 16 is wider than the gap 17 between the pole shoes 16 and the iron core 11. For example, the gap 18 may be about twice to four times as wide as the gap 17. The permanent magnets 15 are firmly connected with the carrier plate 14 and the pole shoes 16 using, for example, an adhesive material. The carrier plate 14 and the pole shoes 16 may be made of a soft magnetic sheet metal. As an alternative to the soft magnetic material, the pole shoes 16 could also be made from a permanent magnetic material or other suitable material. In this case, the permanent magnets 15 and the pole shoes 16 could be formed as a one-piece construction enabling the gap 18 between the pole shoes 16 to be omitted.

In the area of the carrier plate 14, the rotor 9 is rigidly connected with a cutter supporting member 19 mounting two undercutters 20. Fastened to a shaving head frame 22 adjacent to each undercutter 20 is a respective shaving foil 21 bent to conform to the shape of the associated undercutter 20. The cutter supporting member 19 is suspended on the shaving head frame 22 by means of a respective S-shaped oscillating bridge 24 disposed at either end so as to be movable linearly in the direction of movement of the rotor 9, which is indicated by a double arrow 23, and extends parallel to the section plane. The areas of the oscillating bridges 24 oriented transversely to the direction of movement of the rotor 9 are each made of a thin, high-vibration-resistant material as, for example, spring steel. Formed approximately in the center of these areas is a respective aperture through which resonant spring 25 is passed. The resonant spring 25 is held in tension between the cutter supporting member 19 and the shaving head frame 22 and in combination with the rotor 9, the cutter supporting member 19 and the undercutters 20, form an oscillatory system with a defined resonant frequency.

Furthermore, a sensor 26 may be arranged in the shaving head 4 in close proximity to the rotor 9 and is connected to the electronic control unit 10 through a signal line 27. In one configuration, the sensor 26 detects a variable indicative of the state of motion of the rotor 9 (e.g., the rotor velocity or oscillation amplitude). In still other configurations, the sensor 26 detects a variable that is indicative of the state of motion of one of the oscillating bridges 24, the cutter supporting member 19, or one of the undercutters 20.

With the shaving apparatus 1 in operation, the rotor 9 executes linear oscillations with a frequency that corresponds or is close to the resonant frequency of the oscillatory system. In one configuration the linear motor 7 operates very efficiently enabling relatively low power to be used. To set the rotor 9 and hence also the undercutters 20 in an oscillatory motion, the winding 12 of the stator 8 is driven by the electronic control unit 10 via bipolar voltage pulses of variable pulse width, that produce a short-time magnetic field in the iron core 11 that acts on the pole shoes 16 of the rotor 9. The geometry of the magnetic field is determined by the shape of the iron core 11. Depending on the direction of the magnetic field, which is in turn dependent on the direction of the current in the winding 12 and hence on the polarity of the voltage pulses produced by the electronic control unit 10, the rotor 9 is deflected from the mid-position shown in FIG. 1 to either the left or to the right. The repeated application of voltage pulses to the winding 12 at appropriate instants of time results in a linear oscillation parallel to the pivot axis 6 of the shaving head 4 with a frequency corresponding or close to the resonant frequency of the oscillatory system.

The generation of the voltage pulses applied to the winding 12 at the proper instants of time can be achieved in a variety of suitable ways. In a first variant, the electronic control unit 10 produces voltage pulses of a predetermined frequency which correspond or are close to the resonant frequency of the oscillatory system. These pulses excite the rotor 9 into executing corresponding oscillations synchronously with the voltage pulses of the electronic control unit 10. In a second variant, a self-oscillating loop is formed by feeding a signal dependent on the oscillation of the rotor 9 back to the electronic control unit 10. For example, the signal could be generated by the sensor 26. Due to the feedback, the winding 12 is driven by the electronic control unit 10 such that the oscillation frequency of the rotor 9 corresponds to the resonant frequency of the oscillatory system or is close to the resonant frequency.

The oscillation amplitude of the rotor 9 may be adjusted to a constant value by the electronic control unit 10 during the shave. To this effect, the oscillation amplitude or the velocity of the rotor 9 is detected as an actual value and compared to a desired value. The deviation determined by the comparison is fed to a filter exhibiting, for example, a proportional-integral characteristic, which generates an actuating signal. A power unit then uses the actuating signal to produce bipolar voltage pulses for driving the winding 12 of the stator 8. In the process, the power unit varies the drive power in response to the actuating signal, for example, by pulse duration modulation of the voltage pulses delivered to the winding 12. The actual values necessary for control of the oscillation amplitude may be detected by the sensor 26 which is arranged in the shaving head 4.

In some configurations a detector device which is arranged wholly or in part in the housing 2 of the shaving apparatus 1 may be employed. For example, the rotor 9 may have secured to it a permanent-magnetic pickup whose motion is detected by an inductive coil disposed in the housing 2. Further, it will be understood by those of ordinary skill in the art that the permanent magnets 15 which are present anyway could also be used as pickups. In a further aspect, it is also possible to dispense with a concrete detector device altogether and to determine the actual values from the voltages and currents of the winding 12 of the stator 8.

FIG. 2 shows the embodiment of the shaving apparatus 1 illustrated in FIG. 1 in a further schematic sectional view in which the section is taken along the line A-A drawn in FIG. 1. This means that the section is taken transversely to the direction of movement of the rotor 9 and parallel to the pivot direction of the shaving head 4. The pivoting direction of the shaving head 4 is indicated by arrows 28. In the representation of FIG. 2, the shaving foils 21 are removed from the shaving head 4 and hence not shown.

To operate the rotor 9, which is pivoted along with the shaving head 4, also in a pivoted position of the shaving head 4, which differs from the mid-position shown in FIG. 2, the gap 17 between the pole shoes 16 of the rotor 9 and the iron core 11 of the stator 8 may be of approximately like width for all the permitted pivot angles. In one configuration, this is accomplished by arranging the pivot axis 6 at a relatively large distance from this gap 17 and by conformability shaping the adjacent outer contours of the pole shoes 16 and of the iron core 11. To this effect, the iron core 11 may be curved to a concave configuration in this area. Correspondingly, the pole shoes 16 may be curved to a convex configuration, with the curvature being the same or similar. For example, the curvature may be in particular of a circular-arc shape, with the center of the circle lying on or in close vicinity to the pivot axis 6. It is also possible to provide for an intentional minor variation in the width of the gap 17, dependent on the pivot angle of the shaving head 4, in order to compensate for a dependence, if any, of the drive power of the linear motor 7 on the pivot angle.

Furthermore, some configurations can compensate for the effects of an unwanted variation in the width of the gap 17 on the drive power of the linear motor 7 by appropriately driving the winding 12 of the stator 8. In this way, dependences of the drive power of the linear motor 7 on the pivot angle of the shaving head 4 can be counteracted. In particular, the power loss which occurs in the presence of large pivot angles when the overlap between the pole shoes 16 and the iron core 11 decreases and can be balanced out to a certain degree. In this manner, a wide pivot angle range is accomplishable without little or no appreciable power losses of the linear motor 7.

The linear motor 7 may be used to drive not only the undercutters 20 but also the shaving foils 21 or a center cutting comb (not shown) for example. In this case, provision is made for several rotor units which, when taken in combination, have approximately the outer contour of the rotor 9 shown in FIGS. 1 and 2. For example, two rotor units could be provided, whereof one rotor unit is coupled to the undercutters 20 and the other rotor unit to the shaving foils 21. The rotor units are each movably suspended via oscillating bridges 24 of their own and can all be driven by the stator 8 whose construction is maintained unchanged. In this arrangement, different oscillation amplitudes can be generated by equipping the rotor units with pole shoes 16 of different size. Similarly, the rotor units can be set in oscillations in phase opposition to each other by designing the rotor units to exhibit opposite magnetic polarity.

A number of embodiments of the invention have been described. Nevertheless, it will be understood that various modifications may be made without departing from the spirit and scope of the invention. For example, in other embodiments, other suitable shaving systems or motors may be employed. Accordingly, other embodiments are within the scope of the following claims.

What is claimed is:

1. An electric shaving apparatus comprising:
a housing;
a shaving head pivotal relative to the housing and including at least one shaving system; and
an electric drive mechanism for driving at least one component of the shaving system, wherein the drive mechanism comprises a stationary stator and at least one rotor movable relative to the stator wherein the stator is disposed in the housing and the rotor is disposed in the shaving head.

2. The shaving apparatus of claim 1, comprising a gap formed between the stator and the rotor, wherein the stator and the rotor are shaped such that the drive mechanism continues to be operable even though the shaving head inclusive of the rotor are pivoted relative to the housing.

3. The shaving apparatus of claim 2, wherein the stator and the rotor are shaped in the region adjoining the gap in such manner that the magnetically effective width of the gap is maintained substantially constant as the shaving head is being pivoted.

4. The shaving apparatus of claim 2, wherein the stator is curved to a concave configuration in the region adjoining the gap and/or the rotor is curved to a convex configuration in the region adjoining the gap.

5. The shaving apparatus of claim 1, wherein the shaving head is pivotal about a pivot axis that extends parallel to the direction of movement of the driven component of the shaving system.

6. The shaving apparatus of claim 1, wherein the rotor is connected rigidly with the driven component of the shaving system.

7. The shaving apparatus of claim 1, wherein the rotor is movably suspended on the shaving head.

8. The shaving apparatus of claim 1, wherein the rotor is coupled to at least one element that is resilient parallel to the direction of movement of the rotor.

9. The shaving apparatus of claim 1, wherein the rotor is rigidly connected with the shaving head parallel to the pivoting direction of the shaving head.

10. The shaving apparatus of claim 1, wherein the rotor is fastened to the shaving head by oscillating bridges.

11. The shaving apparatus of claim 1, wherein the rotor comprises at least one permanent magnet.

12. The shaving apparatus of claim 11, comprising a pole shoe disposed on a side of the permanent magnet facing the stator.

13. The shaving apparatus of claim 1, comprising a plurality of rotors which drive a plurality of components of the shaving system.

14. The shaving apparatus of claim 1, wherein the stator comprises at least one winding adapted to be driven by a control device.

15. The shaving apparatus of claim 14, wherein the winding is drivable by the control device such that the drive mechanism is operated at approximately its resonant frequency.

16. The shaving apparatus of claim 14, wherein the control device is configured to produce bipolar voltage pulses.

17. The shaving apparatus of claim 16, wherein the bipolar voltage pulses comprise pulse-duration modulated voltage pulses.

18. The shaving apparatus of claim 14, wherein the control device configured to compensate for variations in the effective power of the drive mechanism by driving of the winding.

19. The shaving apparatus of claim 14, wherein the motion amplitude of the rotor is adjustable to an approximately constant value by the control device through the driving of the winding.

20. The shaving apparatus of claim 1, comprising a sensor configured to detect a variable indicative of the state of motion of the rotor.

21. An electric drive mechanism for driving at least one component of a shaving system of a shaving head pivotal relative to a housing of an electric shaving apparatus, the electric drive mechanism comprising:
a stationary stator mounted in the housing; and
at least one rotor movable relative to the stator, wherein the rotor is mounted in the shaving head of the shaving apparatus.
